(19) United States
(12) Patent Application Publication
(10) Pub. No.: US 2026/0069043 A1
(43) Pub. Date: Mar. 12, 2026

(54) SEAT ASSEMBLY

(71) Applicant: Lear Corporation, Southfield, MI (US)

(72) Inventors: Sumanth Muthyala, Ann Arbor, MI (US); Nikolay Yakovenko, West Bloomfield, MI (US); Sajad Arabnejad, Ann Arbor, MI (US)

(73) Assignee: Lear Corporation, Southfield, MI (US)

(21) Appl. No.: 19/311,927

(22) Filed: Aug. 27, 2025

Related U.S. Application Data
(60) Provisional application No. 63/691,729, filed on Sep. 6, 2024.

(51) Int. Cl. A47C 7/72; G01S 7/02; G01S 13/06

(52) U.S. Cl. CPC A47C 7/72; G01S 7/027; G01S 13/06

(57) ABSTRACT

A seat assembly, comprising: a seat back, comprising: a seat back frame; a cushion coupled with the seat back frame; a mounting bracket coupled with the seat back frame; and a radar system configured to generate a radar cone and coupled with the mounting bracket, the radar system comprising a radar sensor; wherein at least one of a size or a position of the radar cone is adjustable.

### CROSS-REFERENCE TO RELATED APPLICATION

This application claims the benefit of and priority to U.S. Provisional Application 63/691,729 filed Sep. 6, 2024, the disclosure of which is hereby incorporated by reference in its entirety as though fully set forth herein.

### TECHNICAL FIELD

The present disclosure generally relates to seat assemblies, including seat assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic side view generally illustrating an embodiment of a seat assembly according to teachings of the present disclosure.

FIGS. 2A, 2B, and 2C are schematic side views generally illustrating portions of an embodiment of a seat assembly with a radar system in default, raised, and lowered positions, respectively, according to teachings of the present disclosure.

FIGS. 3A, 3B, and 3C are schematic side views generally illustrating portions of an embodiment of a seat assembly with a radar system in default, raised, and lowered positions, respectively, according to teachings of the present disclosure.

FIG. 4 is a schematic side view generally illustrating portions of an embodiment of a seat assembly according to teachings of the present disclosure.

FIG. 5 is a schematic side view generally illustrating portions of an embodiment of a seat assembly according to teachings of the present disclosure.

FIG. 6 is a flow diagram generally illustrating an embodiment of a method of operating a seat assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

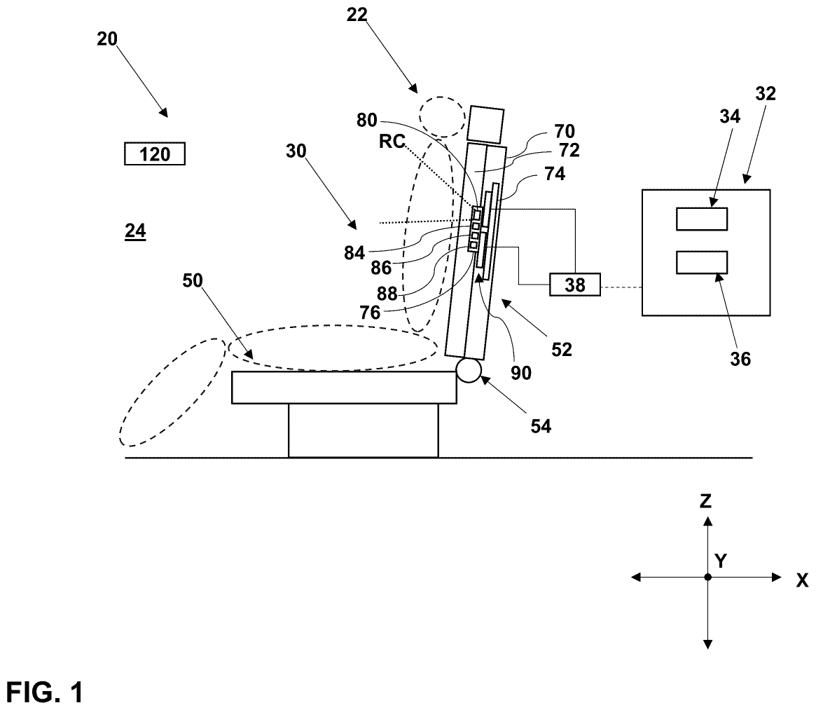

Referring to FIG. 1, a seat assembly 20 is illustrated with a seat 30 and an electronic controller 32 including a processor 34 and a memory 36. The seat 30 is configured to support an occupant 22. The seat assembly 20 is illustrated in a vehicle 24 (e.g., a passenger car, a truck, a bus, a plane, a boat, among others), but can be utilized in other applications. The seat 30 includes a seat base 50 and a seat back 52 coupled to the seat base 50, such as via a recliner 54. The seat assembly 20 defines a longitudinal direction X, a transverse direction Y, and a vertical direction Z.

The seat back 52 includes a seat back frame 70, a cushion 72 coupled with the seat back frame 70, a mounting bracket 74 coupled with the seat back frame 70, and a radar system 76. The radar system 76 includes a radar sensor 80. The radar sensor 80 is configured to monitor one or more characteristics of the occupant 22, such as one or both of heart rate or breathing rate, and/or can be utilized as an occupancy sensor to determine if the seat 30 is occupied by the occupant 22. For example, the radar sensor 80 is configured to generate a radar cone RC directed at the occupant 22 (e.g., at the lungs and/or the heart of the occupant 22). The radar cone RC is not limited to a conical shape, and can include a cone, a beam, or other shapes or antenna patterns. The radar sensor 80 includes, for example, a radar transmitter and/or antenna, which can be disposed on a chip. Optionally, the radar system 76 includes a gyroscope 84, an accelerometer 86, and/or an inertial motion unit (IMU) 88, which can include one or both of the gyroscope 84 or the accelerometer 86. The shape and/or position of the radar code RC is adjustable via control of the radar system 76 and/or an actuator 90, such as by the electronic controller 32.

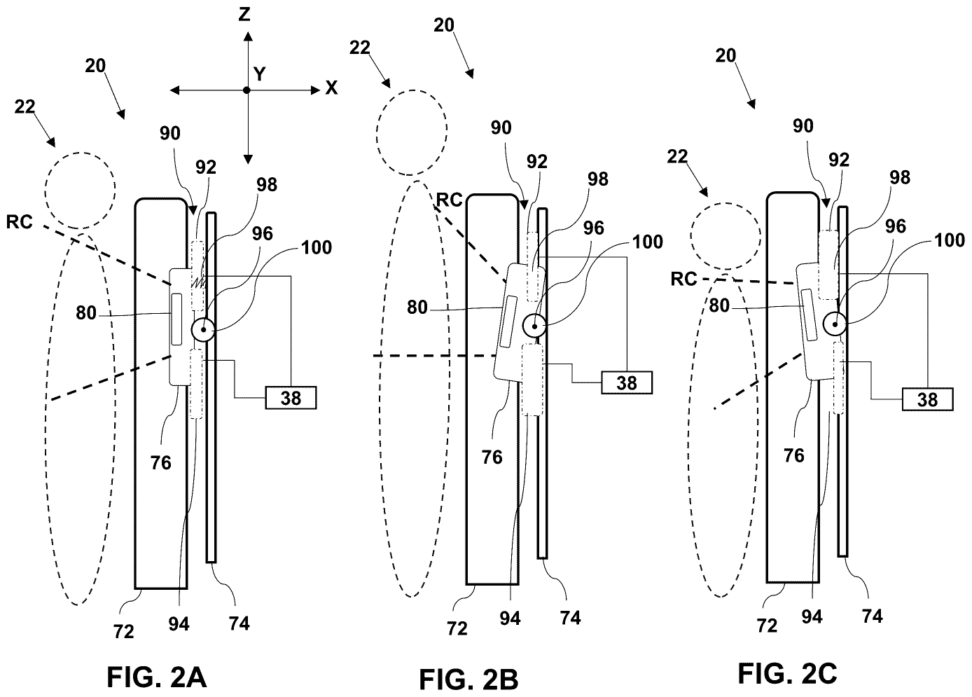

Referring to the example illustrated in FIG. 2A 2B, and 2C, the actuator 90 moves the radar system 76, including the radar sensor 80 (and the radar cone RC), to and/or between a default position shown in FIG. 2A, a raised position shown in FIG. 2B, and/or a lowered position shown in FIG. 2C. Optionally, the default position corresponds to occupants 22 of average height.

In the illustrated example, the actuator 90 comprises a first bladder 92 and a second bladder 94 fluidly coupled to an air source 38 (e.g., a pump, a valve, a tank, other components, or combinations thereof). The first and second bladders 92, 94 are disposed at least partially between the mounting bracket 74 and the radar system 76. The radar system 76 and/or the radar sensor 80 are movably (e.g., rotatably) coupled with the mounting bracket 74. For example, the radar system 76, including the radar sensor 80, is rotatably coupled with the mounting bracket 74 by a hinge 100 to rotate about a rotational axis 96. The rotational axis 96 is parallel with the transverse direction Y. The first bladder 92 and the second bladder 94 are disposed at opposite sides of the rotational axis 96. For example, the first bladder 92 is disposed below the rotational axis 96, and the second bladder 94 is disposed above the rotational axis 96. The first bladder 92 and/or the second bladder 94 are configured to adjust the position of the radar system 76 and/or the radar sensor 80 to adjust the position of the radar cone RC. For example, the electronic controller 32 controls the air source 38 to inflate the first bladder 92 to cause the radar system 76 and/or the radar sensor 80 to rotate about the rotational axis 96 in a first direction (e.g., clockwise in FIGS. 2A-2C), which moves (e.g., angles) the radar cone RC upward, such as generally illustrated in FIG. 2B. The electronic controller 32 controls the air source 38 to inflate the second bladder 94 to cause the radar system 76 and/or the radar sensor 80 to rotate about the rotational axis 96 in a second direction (e.g., counterclockwise in FIGS. 2A-2C) that is opposite the first direction, which moves (e.g., angles) the radar cone RC downward, such as generally illustrated in FIG. 2C. Moving (e.g., angling) the radar cone RC upward can better align the radar cone RC with the heart and/or lungs of the taller occupants 22, which improves accuracy of measurements by the radar system 76 for such taller occupants. Moving (e.g., angling) the radar cone RC downward can better align the radar cone RC with the heart and/or lungs of shorter occupants, which improves accuracy of the measurements by the radar system 76 for such shorter occupants.

Optionally, the seat back 52 includes a spring 98 (FIG. 2A) that biases the radar system 76 and/or the radar sensor 80 in the first direction or the second direction. For example, the spring 98 can bias the radar system 76 and/or the radar sensor 80 in the second direction. Optionally, the spring 98 is used instead of the second bladder 94.

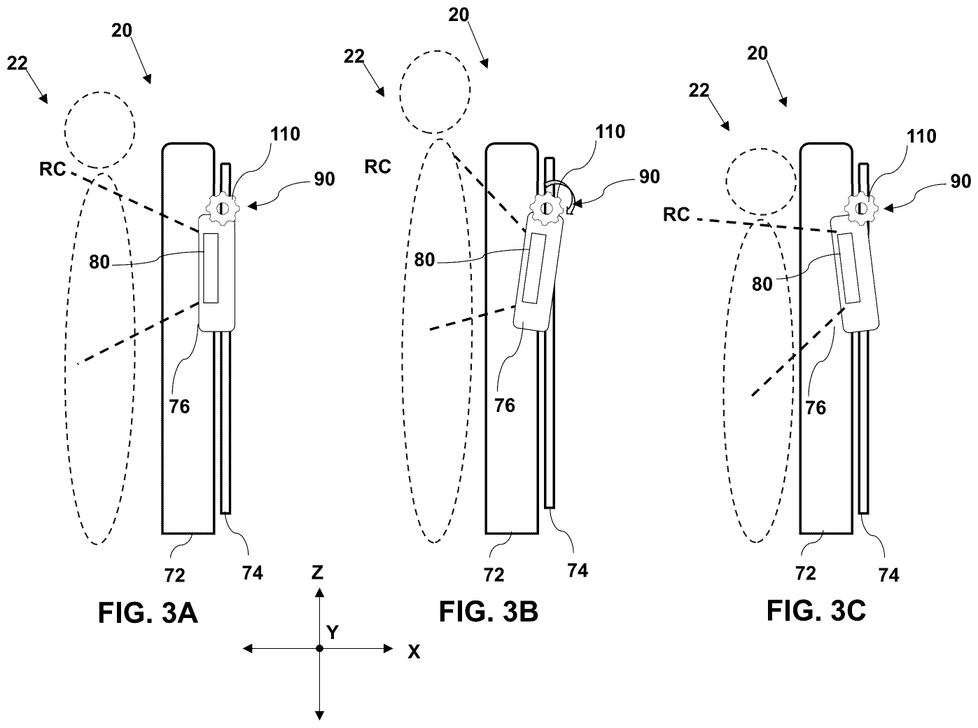

Referring to FIGS. 3A, 3B, and 3C, the actuator 90 includes a motor 110 configured to adjust the position of the radar code RC, such as in addition to or instead of the first and second bladders 92, 94. The motor 110 is operably coupled with the radar system 76 and/or the mounting bracket 74 to move (e.g., rotate, translate, etc.) the radar system 76. For example, the motor 110 rotates the radar system 76, including the radar sensor 80 (and the radar cone RC), about the rotational axis 96 to and between the default position shown in FIG. 3A, the raised position shown in FIG. 3B, and/or the lowered position shown in FIG. 3C.

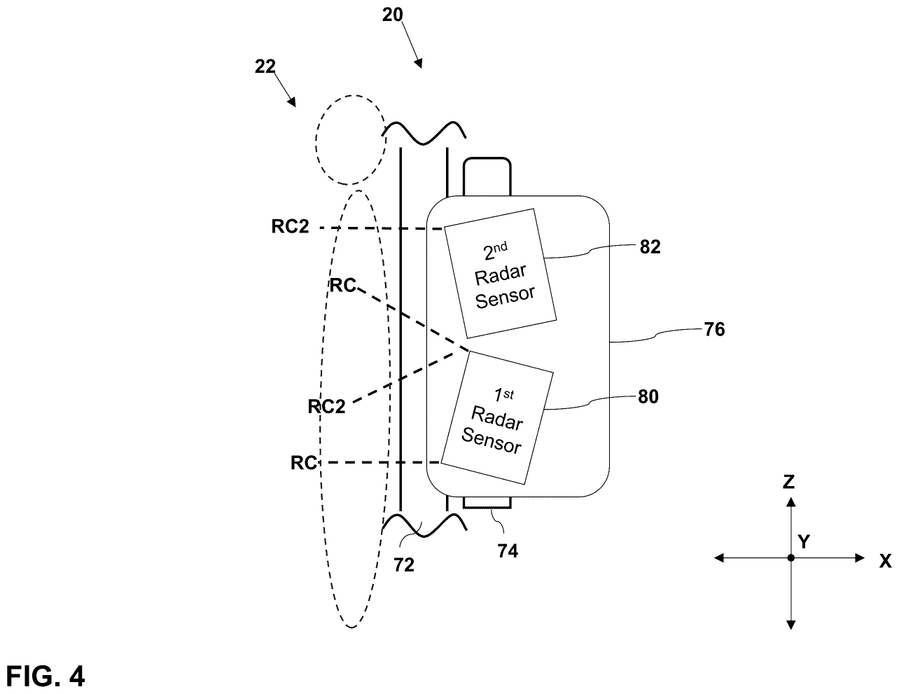

Referring to FIG. 4, the radar system 76 optionally includes the radar sensor 80 (e.g., a first radar sensor 80) and a second radar sensor 82. The second radar sensor 82 generates a second radar cone RC2 that is disposed at least partially above the radar cone RC (e.g., a first radar cone). The first radar sensor 80 can be utilized for occupants 22 with a range of heights (e.g., within a threshold of an average height), and the second radar sensor 82 can be activated for taller occupants, such as in addition to or instead of the first radar sensor 80.

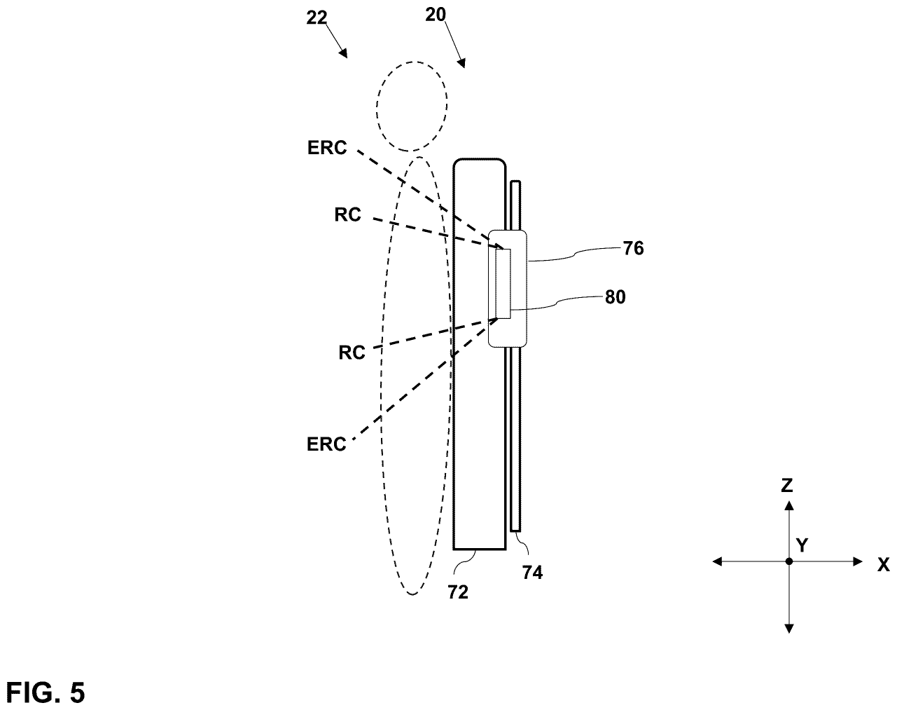

Referring to FIG. 5, the radar sensor 80 is optionally configured to adjust the size of the radar code RC, such as by adjusting one or more of power, gain, beam steering, pulse width, repetition frequency, and/or antenna pattern control. For example, increasing the gain of the radar sensor 80 can increase the size (e.g., angular extent) of the radar cone RC to provide an extended radar cone ERC. The extended radar cone ERC extends farther upward to accommodate taller occupants. Additionally or alternatively, the extended radar cone ERC extends farther downward to accommodate shorter occupants.

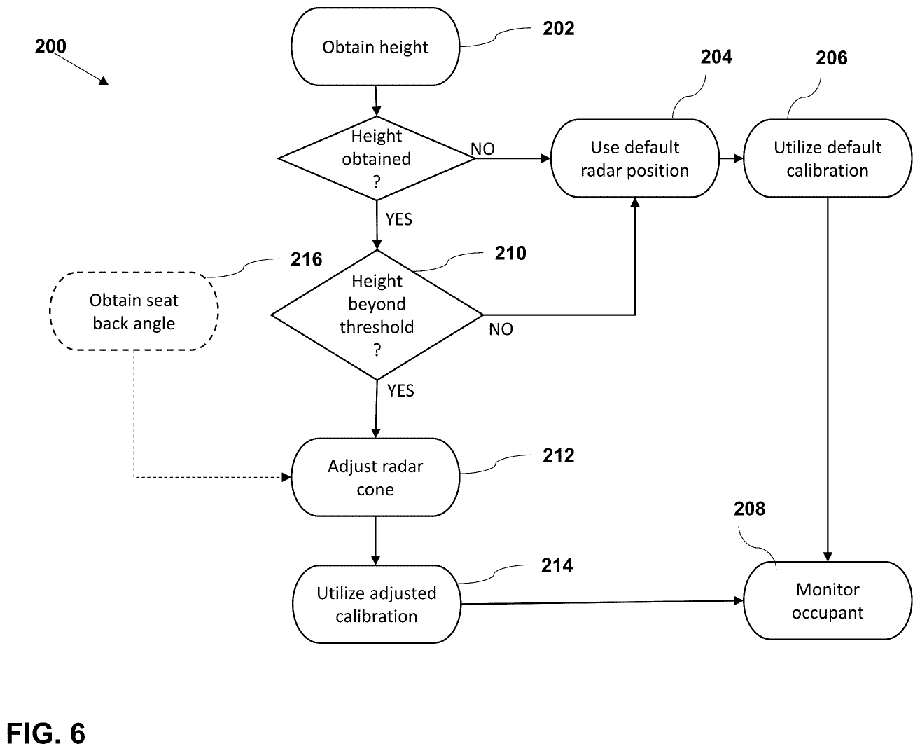

Referring to FIG. 6, a method 200 of operating a seat assembly 20 is illustrated. The method 200 includes obtaining a height of the occupant 22 (block 202), which can include the electronic controller 32 obtaining the height from the occupant 22 (e.g., via a user interface), from a user profile associated with the occupant 22, and/or from one or more height sensors 120 (FIG. 1), such as a camera. If the electronic controller 32 is not able to obtain the height, the electronic controller 32 utilizes a default radar cone position (block 204), applies a default calibration for the radar system 76 (block 206), and monitors the occupant 22 in block 208 utilizing the default position and calibration, such as to obtain a heart rate, a breathing rate, or both, of the occupant 22.

If the electronic controller 32 obtains the height, the electronic controller 32, in block 210, compares the height to a threshold (e.g., a height or range of heights). If the obtained height is within the threshold, the method 200 proceeds to block 204, and the electronic controller 32 utilizes the default radar cone position. If the obtained height is beyond the threshold, such as for taller or shorter occupants 22, the electronic controller 32 adjusts the radar cone RC (block 212), such as at least one of the size or the position of the radar cone. Adjusting the radar cone position in block 212 optionally includes moving the radar system 76 via the actuator 90, such as via one or more bladders 92, 94 and/or via the motor 110. For example, for heights greater than the threshold, the electronic controller 32 moves (e.g., rotates) the radar system 76 and/or the radar sensor 80 upward, such as by inflating the first bladder 92 and/or by operating the motor 110 in the first direction. For heights less than the threshold, the electronic controller 32 moves (e.g., rotates) the radar system 76 and/or the radar sensor 80 downward, such as by inflating the second bladder 94 (or deflating the first bladder 92 to allow the spring 98 to cause the downward rotation) and/or operating the motor 110 in the second direction. Adjusting the radar cone RC (block 212) optionally includes increasing the gain of the radar sensor 80 to widen the angle of the radar cone RC. Adjusting the radar cone RC (block 212) optionally includes utilizing a second radar cone RC2 generated by a second radar sensor 82. The method 200 includes the electronic controller 32 utilizing an adjusted calibration for the radar system 76 corresponding to the radar cone adjustments (block 214) and monitoring the occupant in block 208 utilizing the adjusted radar system 76 with the adjusted calibration, such as to obtain a heart rate, a breathing rate, or both, of the occupant 22.

Optionally, the method 200 includes obtaining a seat back angle of the seat back 52 (block 216). For example, the electronic controller 32 may obtain the seat back angle from the gyroscope 84, the accelerometer 86, and/or the IMU 88 (FIG. 1) of the radar system 76 and/or the recliner 54. The seat back angle is measured relative to vertical such that large seat back angles correspond to the seat back 52 being reclined closer to, at, or beyond horizontal. With smaller seat back angles, the effective height of the occupant 22 tends to be greater such that the heart and lungs of the occupant 22 are disposed at higher positions relative to the seat back 52 and the radar system 76. With larger seat back angles, the effective height of the occupant tends to be shorter such that the heart and lungs of the occupant 22 are disposed a lower positions relative to the seat back 52 and the radar system 76. Adjusting the radar cone RC (block 214) can include adjusting the radar cone RC, at least in part, according to the obtained height and the obtained seat back angle. For example, the electronic controller 32 can further lower the radar cone RC for shorter occupants that are reclined with a larger seat back angle, and can further raise the radar cone RC for taller occupants that are sitting with the seat back 52 at smaller seatback angles (e.g., in more upright positions).

Embodiments of seat assemblies disclosed herein can, for example, provide increased accuracy for monitoring characteristics of seat occupants, such as compared to designs that are not configured to provide adjustable radar cones and/or designs that do not adjust a radar cone according to a seat back angle.

The instant disclosure includes the following non-limiting embodiments:

A seat assembly, comprising: a seat back, comprising: a seat back frame; a cushion coupled with the seat back frame; a mounting bracket coupled with the seat back frame; and a radar system configured to generate a radar cone and coupled with the mounting bracket, the radar system comprising a radar sensor; wherein at least one of a size or a position of the radar cone is adjustable.

The seat assembly of any preceding embodiment, wherein the seat back further comprises an actuator configured to adjust the position of at least one of the mounting bracket or the radar system, the actuator adjusting the position of the radar cone and comprising at least one of a motor or a bladder.

The seat assembly of any preceding embodiment, wherein the radar system is movably coupled to the mounting bracket.

The seat assembly of any preceding embodiment, wherein the radar system is rotatably coupled to the mounting bracket; and the actuator is configured to rotate the radar system to adjust the position of the radar cone.

The seat assembly of any preceding embodiment, further comprising an electronic controller operably coupled with the radar system and the actuator.

The seat assembly of any preceding embodiment, wherein the electronic controller is configured to obtain a height of an occupant and control operation of the actuator according to the height.

The seat assembly of any preceding embodiment, wherein the electronic controller is configured to obtain a seat back angle and control operation of the actuator according to the seat back angle and the height.

The seat assembly of any preceding embodiment, wherein the radar system includes a gyroscope; and the electronic controller is configured to determine the seat back angle, at least in part, via the gyroscope.

The seat assembly of any preceding embodiment, wherein the actuator includes the bladder, and the bladder is configured to cause rotation of the radar system to adjust the position of the radar cone.

The seat assembly of any preceding embodiment, further comprising a spring; wherein the bladder is configured to cause rotation of the radar system in a first direction; and the spring biases the radar system in a second direction opposite the first direction.

The seat assembly of any preceding embodiment, wherein the bladder is a first bladder; and the actuator includes a second bladder.

The seat assembly of any preceding embodiment, wherein the first bladder is configured to cause rotation of the radar system in a first direction; and the second bladder is configured to cause rotation of the radar system in a second direction opposite the first direction.

The seat assembly of any preceding embodiment, wherein the first bladder and the second bladder are disposed at a front side of the mounting bracket.

The seat assembly of any preceding embodiment, wherein the radar system is configured to rotate about a rotation axis; and the first bladder and the second bladder are disposed at opposite sides of the rotation axis.

The seat assembly of any preceding embodiment, wherein the first bladder is disposed below the rotation axis and the second bladder is disposed above the rotation axis.

The seat assembly of any preceding embodiment, wherein the radar sensor is a first radar sensor; and the radar system includes a second radar sensor for occupants having heights greater than a threshold.

The seat assembly of any preceding embodiment, wherein the radar system includes at least one of an accelerometer or a gyroscope.

The seat assembly of any preceding embodiment, further comprising an electronic controller operably coupled with the radar system and configured to obtain a height of an occupant.

The seat assembly of any preceding embodiment, wherein the electronic controller is configured to adjust a gain of the radar sensor, at least in part, according to the height to adjust the size of the radar cone.

The seat back of any preceding embodiment.

The seat assembly of any preceding embodiment comprising a seat base coupled with the seat back via a recliner.

A method of operating the seat assembly of any preceding embodiment, the method comprising: obtaining a height of an occupant; and controlling, via an electronic controller, an actuator to adjust a position of the radar system according to the height of the occupant, the actuator comprising at least one of a motor or a fluid bladder.

An electronic controller configured to implement the method of any preceding embodiment.

A non-transitory computer-readable storage medium having a computer program encoded thereon for implementing the method of any preceding embodiment.

A vehicle comprising the seat assembly of any preceding embodiment.

In examples, a controller (e.g., the electronic controller 32) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

References to a vehicle can include one or more of a variety of vehicles, including, without limitation, a passenger car, a truck, a bus, a plane, or a boat, among others.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A seat assembly, comprising:
a seat back, comprising:
a seat back frame;
a cushion coupled with the seat back frame;
a mounting bracket coupled with the seat back frame; and
a radar system configured to generate a radar cone and coupled with the mounting bracket, the radar system comprising a radar sensor;
wherein at least one of a size or a position of the radar cone is adjustable.

2. The seat assembly of claim 1, wherein the seat back further comprises an actuator configured to adjust the position of at least one of the mounting bracket or the radar system, the actuator adjusting the position of the radar cone and comprising at least one of a motor or a bladder.

3. The seat assembly of claim 2, wherein the radar system is movably coupled to the mounting bracket.

4. The seat assembly of claim 2, wherein the radar system is rotatably coupled to the mounting bracket; and
the actuator is configured to rotate the radar system to adjust the position of the radar cone.

5. The seat assembly of claim 4, further comprising an electronic controller operably coupled with the radar system and the actuator.

6. The seat assembly of claim 5, wherein the electronic controller is configured to obtain a height of an occupant and control operation of the actuator according to the height.

7. The seat assembly of claim 6, wherein the electronic controller is configured to obtain a seat back angle and control operation of the actuator according to the seat back angle and the height.

8. The seat assembly of claim 7, wherein the radar system includes a gyroscope; and
the electronic controller is configured to determine the seat back angle, at least in part, via the gyroscope.

9. The seat assembly of claim 4, wherein the actuator includes the bladder, and the bladder is configured to cause rotation of the radar system to adjust the position of the radar cone.

10. The seat assembly of claim 9, further comprising a spring;
wherein the bladder is configured to cause rotation of the radar system in a first direction; and
the spring biases the radar system in a second direction opposite the first direction.

11. The seat assembly of claim 9, wherein the bladder is a first bladder; and
the actuator includes a second bladder.

12. The seat assembly of claim 11, wherein the first bladder is configured to cause rotation of the radar system in a first direction; and
the second bladder is configured to cause rotation of the radar system in a second direction opposite the first direction.

13. The seat assembly of claim 12, wherein the first bladder and the second bladder are disposed at a front side of the mounting bracket.

14. The seat assembly of claim 13, wherein the radar system is configured to rotate about a rotation axis; and
the first bladder and the second bladder are disposed at opposite sides of the rotation axis.

15. The seat assembly of claim 14, wherein the first bladder is disposed below the rotation axis and the second bladder is disposed above the rotation axis.

16. The seat assembly of claim 1, wherein the radar sensor is a first radar sensor; and
the radar system includes a second radar sensor for occupants having heights greater than a threshold.

17. The seat assembly of claim 1, wherein the radar system includes at least one of an accelerometer or a gyroscope.

18. The seat assembly of claim 1, further comprising an electronic controller operably coupled with the radar system and configured to obtain a height of an occupant.

19. The seat assembly of claim 18, wherein the electronic controller is configured to adjust a gain of the radar sensor, at least in part, according to the height to adjust the size of the radar cone.

20. A method of operating the seat assembly of claim 1, the method comprising:
obtaining a height of an occupant; and
controlling, via an electronic controller, an actuator to adjust a position of the radar system according to the height of the occupant, the actuator comprising at least one of a motor or a fluid bladder.
